(19) United States
(12) Patent Application Publication
(10) Pub. No.: US 2025/0070418 A1
(43) Pub. Date: Feb. 27, 2025

(54) SECONDARY BATTERY

(71) Applicant: SAMSUNG SDI CO., LTD., Yongin-si (KR)

(72) Inventors: Sang Hyun KIM, Yongin-si (KR); Jeong Chull AHN, Yongin-si (KR); Hiroshi SEINO, Yongin-si (KR); Sun Yang HONG, Yongin-si (KR)

(21) Appl. No.: 18/633,628

(22) Filed: Apr. 12, 2024

(30) Foreign Application Priority Data
Aug. 25, 2023 (KR) 10-2023-0111874

(51) Int. Cl. H01M 50/553; H01M 50/105; H01M 50/131; H01M 50/186; H01M 50/564

(52) U.S. Cl. CPC H01M 50/553; H01M 50/105; H01M 50/131; H01M 50/186; H01M 50/564

(57) ABSTRACT

A secondary battery including an electrode assembly; a case containing the electrode assembly; and a strip terminal including a conductor part connected to the electrode assembly and extending outward, a foaming part surrounding the conductor part and containing foaming particles that foam under predetermined temperature conditions, and an adhesive layer surrounding the foaming part and bonded to the case.

### CROSS-REFERENCE TO RELATED APPLICATION

This application claims priority to and the benefit of Korean Patent Application No. 10-2023-0111874 filed on Aug. 25, 2023, in the Korean Intellectual Property Office, the contents of which in its entirety are herein incorporated by reference.

### BACKGROUND

### 1. Field

Embodiments of the present disclosure relate to a pouch-type secondary battery.

### 2. Description of the Related Art

Lithium ion secondary batteries are used as power sources for hybrid vehicles or electric vehicles as well as portable electronic devices because of, for example, a high operating voltage and a high energy density per unit weight.

The above information disclosed in this Background section is only for enhancement of understanding of the background of the invention and therefore it may contain information that does not constitute prior art.

### SUMMARY

Embodiments are directed to a secondary battery including an electrode assembly; a case containing the electrode assembly; and a strip terminal including a conductor part connected to the electrode assembly and extending outward, a foaming part surrounding the conductor part and containing foaming particles that foam under predetermined temperature conditions, and an adhesive layer surrounding the foaming part and bonded to the case.

The foaming part may at least partially surround the conductor part.

The foaming part may entirely surround the conductor part.

The case may include a lower case, having a concave portion accommodating the electrode assembly, and an upper case, covering the lower case, the case may be thermally bonded along a terrace part of the lower case and a terrace part of the upper case, the conductor part may extend outwardly through the lower case and the upper case, and the adhesive layer may include a lower adhesive layer between the foaming part and the terrace part of the lower case, and an upper adhesive layer between the foaming part and the terrace part of the upper case.

An amount of heat required for the foaming particle to foam may be greater than an amount of heat required to thermally bond the lower case and the upper case.

The lower and upper adhesive layers may each have larger widths than the foaming part.

The lower adhesive layer and the upper adhesive layer may be in contact with each other at opposite ends of the strip terminal in a width direction.

The strip terminal may further include a foaming-part extension part extending from the foaming part to opposite ends of the strip terminal in a width direction, and the lower adhesive layer and the upper adhesive layer may be spaced apart from each other by the foaming-part extension part at the opposite ends of the strip terminal in the width direction.

Opposite ends of the foaming-part extension part in the width direction may coincide with opposite ends of the lower and upper adhesive layers in the width direction.

The strip terminal may further include a heat-resistant layer between the foaming part and the adhesive layer.

The heat-resistant layer may be made of a material having a higher melting point than the adhesive layer.

The case may include a lower case, having a concave portion accommodating the electrode assembly, and an upper case, covering the lower case, the case may be thermally bonded along a terrace part of the lower case and a terrace part of the upper case, the conductor part may extend outwardly between the lower case and the upper case, the adhesive layer may include a lower adhesive layer between the foaming part and the terrace part of the lower case, and an upper adhesive layer between the foaming part and the terrace part of the upper case, and the heat-resistant layer may include a lower heat-resistant layer between the foaming part and the lower adhesive layer and an upper heat-resistant layer between the foaming part and the upper adhesive layer.

An amount of heat required for the foaming particles to foam may be greater than an amount of heat required to thermally bond the lower case and the upper case.

The lower and upper adhesive layers and the lower and upper heat-resistant layers may have larger widths than the foaming part.

The lower adhesive layer and the upper adhesive layer may be in contact with each other at opposite ends of the strip terminal in a width direction.

The strip terminal may further include a foaming-part extension part extending from the foaming part to opposite ends of the strip terminal in a width direction, and the lower heat-resistant layer and the upper heat-resistant layer may be spaced apart from each other by the foaming-part extension part at the opposite ends of the strip terminal in the width direction.

Opposite ends of the foaming-part extension part in the width direction may coincide with opposite ends of the lower and upper adhesive layers in the width direction and opposite ends of the lower and upper heat-resistant layers in the width direction.

The foaming particles may include azodicarbonamide (ADCA), benzene sulfonyl hydrazide (OBSH), or N, N′-dinitroso pentamethylene tetramine (DPT).

Embodiments are directed to a method of manufacturing a strip terminal, the method including placing and preparing for elongation in a width direction a member for forming a lower adhesive layer; placing a material for forming a foaming part and a foaming-part extension part on the member for forming a lower adhesive layer; placing conductor parts spaced at regular intervals in the width direction on the material for forming a foaming part and a foaming-part extension part; placing additional material for forming a foaming part and a foaming-part extension part on the material for forming a second foaming part and a foaming-part extension part and the conductor parts; placing and preparing for elongation in the width direction a member for forming an upper adhesive layer on the additional material for forming a foaming part and a foaming-part extension part; and cutting placed materials at regular intervals along the width direction in spaces between the conductor parts spaced at regular intervals along the width direction.

Embodiments are directed to a method of manufacturing a strip terminal, the method including placing and preparing for elongation in a width direction a member for forming a lower adhesive layer; placing a material for forming a lower heat-resistant layer on the member for forming a lower adhesive layer; placing a material for forming a foaming part and a foaming-part extension part on the material for forming a lower heat-resistant layer; placing conductor parts spaced at regular intervals in the width direction on the material for forming a foaming part and a foaming-part extension part; placing additional material for forming a foaming part and a foaming-part extension part on the material for forming a second foaming part and a foaming-part extension part and the conductor parts; placing a material for forming an upper heat-resistant layer on the additional material for forming a foaming part and a foaming-part extension part; placing and preparing for elongation in the width direction a member for forming an upper adhesive layer on the material for forming an upper heat-resistant layer; and cutting placed materials at regular intervals along the width direction in spaces between the conductor parts spaced at regular intervals along the width direction.

### BRIEF DESCRIPTION OF DRAWINGS

Features will become apparent to those of skill in the art by describing in detail exemplary embodiments with reference to the attached drawings in which:

FIG. 1 is a schematic diagram of a secondary battery according to a first embodiment of the present disclosure;

FIG. 2 is a cross-sectional view taken along line II-II in FIG. 1;

FIG. 3 is a cross-sectional view of a first strip terminal of a secondary battery according to a second embodiment of the present disclosure, showing the corresponding part in FIG. 2;

FIG. 4 shows a process of manufacturing the first strip terminal of the secondary battery according to the second embodiment of the present disclosure;

FIG. 5 is a cross-sectional view of a first strip terminal of a secondary battery according to a third embodiment of the present disclosure, showing the corresponding part in FIG. 2; and

FIG. 6 is a cross-sectional view of a first strip terminal of a secondary battery according to a fourth embodiment of the present disclosure, showing the corresponding part in FIG. 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “and/or” includes any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

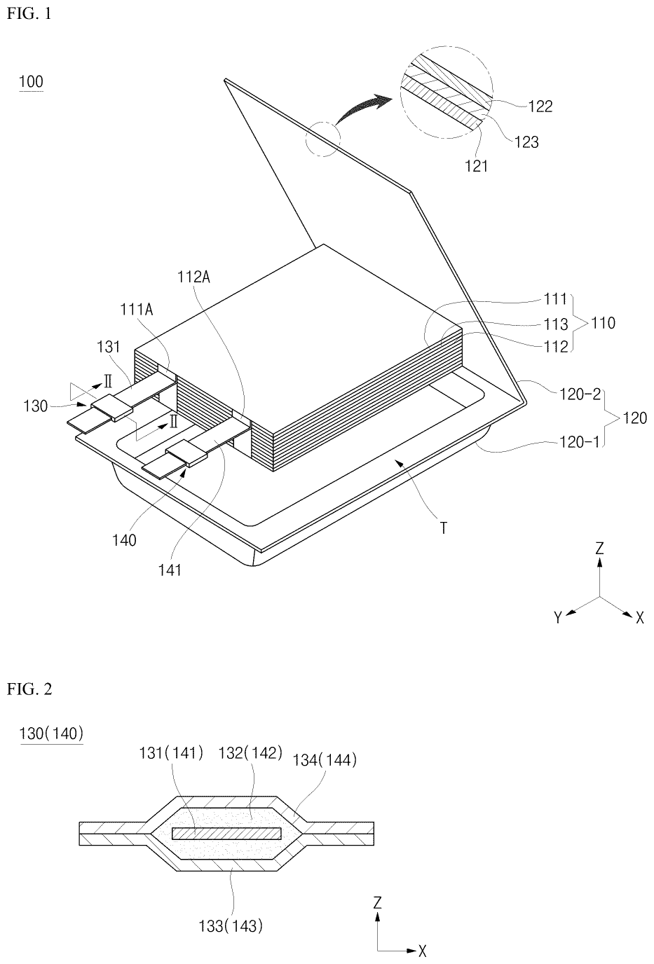

FIG. 1 is a schematic diagram of a secondary battery 100 according to a first embodiment of the present disclosure.

FIG. 2 is a cross-sectional view taken along line II-II in FIG. 1. For reference, FIG. 2 shows the first strip terminal 130. As will be described later, the second strip terminal 140 may have the same structure as the first strip terminal 130, so a second strip terminal 140 will be described by using FIG. 2 without separately attaching a drawing for the second strip terminal 140. In FIG. 2, the reference numerals in parentheses refer to the reference numerals of the components of the second strip terminal 140.

Referring to FIG. 1, the secondary battery 100 according to the first embodiment of the present disclosure may include an electrode assembly 110, a case 120, a first strip terminal 130, and a second strip terminal 140.

The electrode assembly 110 may include a first electrode plate 111, a second electrode plate 112, and a separator 113.

The first electrode plate 111 may be one of a negative electrode plate and a positive electrode plate. In an implementation, if the first electrode plate 111 is a negative electrode plate, the first electrode plate 111 may include a coated portion (negative electrode coated portion) in which an active material (negative electrode active material) is coated on a substrate (negative electrode substrate) formed of a thin conductive metal plate, e.g., a copper or nickel foil or mesh, and an uncoated portion (negative electrode uncoated portion) in which a negative electrode active material is not coated. The negative electrode active material may be made of, e.g., a carbon-based material, Si, Sn, tin oxide, a tin alloy composite, transition metal oxide, lithium metal nitrite, or metal oxide. The first electrode plate 111 may have a first electrode tab 111A. The first electrode tab 111A may be formed separately from the negative electrode uncoated portion and welded to the negative electrode uncoated portion, or may be formed integrally with the negative electrode uncoated portion by punching the negative electrode uncoated portion.

The second electrode plate 112 may be the other of a negative electrode plate and a positive electrode plate. In an implementation, if the second electrode plate 112 is a positive electrode plate, the second electrode plate 112 may include a coated portion (positive electrode coated portion) in which an active material (positive electrode active material) is coated on a substrate (positive electrode substrate) formed of a thin conductive metal plate, e.g., an aluminum foil or mesh, and an uncoated portion (positive electrode uncoated portion) in which a positive electrode active material is not coated. The positive electrode active material may be made of a complex metal oxide such as a chalcogenide compound, e.g., LiCoO₂, LiMn₂O₄, LiNiO₂, or LiNiMnO₂. The second electrode plate 112 may have a second electrode tab 112A. The second electrode tab 112A may be formed separately from the positive electrode uncoated portion and welded to the positive electrode uncoated portion, or may be formed integrally with the positive electrode uncoated portion by punching the positive electrode uncoated portion.

The separator 113 may be between the first electrode plate 111 and the second electrode plate 112 and may serve to prevent a short circuit between the first electrode plate 111 and the second electrode plate 112. The separator 113 may be made of, e.g., polyethylene, polypropylene, or a porous copolymer of polyethylene and polypropylene.

The electrode assembly 110 may be formed by arranging the first electrode plate 111, the separator 113, the second electrode plate 112, and the separator 113 in that order, followed by winding in the form of a so-called jelly roll, or may be formed by repeatedly stacking the first electrode plate 111, the separator 113, the second electrode plate 112, and the separator 113. In an implementation, first electrode tabs 111A may be aligned on one side of the electrode assembly 110, and second electrode tabs 112A may be aligned on the other side of the electrode assembly 110.

The case 120 may be formed in a pouch shape. In an implementation, the case 120 may include a lower case 120-1 having a concave portion to accommodate the electrode assembly 110, and an upper case 120-2 covering the lower case 120-1.

The lower case 120-1 and the upper case 120-2 may be formed in a multi-layer structure including an internal insulating layer 121, an external insulating layer 122, and a metal layer 123. For example, the lower case 120-1 and the upper case 120-2 may both individually be formed of a multi-layer structure and may respectively include an internal insulating layer 121, an external insulating layer 122, and a metal layer 123.

The internal insulating layer 121 may be a part of the inner surface of the case 120 and may be made of a material that does not react with an electrolyte and has insulating properties and thermal bondability, e.g., casted polypropylene (CPP). In an implementation, the internal insulating layer 121 may be made of a material that has thermal bondability when exposed to at least 100° C. for about 2-3 seconds. For example, the internal insulating layer 121 may be made of a material that can be thermally bonded if exposed to at least 100° C. for about 2-3 seconds.

The external insulating layer 122 is a part of the outer surface of the case 120 and may be made of an insulating material, e.g., nylon, polyethylene terephthalate (PET), polybutylene terephthalate (PBT), polybutylene naphthalate (PBN), etc.

The metal layer 123 may be between the internal insulating layer 121 and the external insulating layer 122 to help prevent moisture and oxygen from entering from the outside and the electrolyte from leaking from the inside, while maintaining the mechanical strength of the case 120. The metal layer 123 may be made of, e.g., aluminum.

The lower case 120-1 and the upper case 120-2 may be formed separately or may be integrally connected on one side and folded so that the upper case 120-2 covers the lower case 120-1.

In an implementation, the lower case 120-1 and the upper case 120-2 may be thermally bonded along the perimeter. The perimeter that is thermally bonded may be called a terrace part T.

The first strip terminal 130 may be drawn out from the electrode assembly 110. For example, the first strip terminal 130 may extend from the electrode assembly. In an implementation, referring to FIG. 2, the first strip terminal 130 may include a first conductor part 131, a first foaming part 132, a first lower adhesive layer 133, and a first upper adhesive layer 134.

The first conductor part 131 may be welded to the first electrode tab 111A of the first electrode plate 111 of the electrode assembly 110 and may extend outward between the lower case 120-1 and the upper case 120-2. The first conductor part 131 may be made of, e.g., copper, a copper alloy, nickel, a nickel alloy, nickel-plated copper, etc. In an implementation, if the first conductor part 131 is made of nickel, the first conductor part 131 may have a thermal conductivity of approximately 70-80 W/mK, and, e.g., if the first conductor part 131 has a thickness of 80 μm, a width of 50 mm, and a length of 40 mm, the first conductor part 131 may have resistance of approximately 0.7-0.8 mΩ. In this case, when an overcurrent of 25 A was applied for about 90 seconds, it was observed that the first conductor part 131 generated heat of about 150-160° C.

The first foaming part 132 may at least partially surround the first conductor part 131. In FIG. 2, the first foaming part 132 is illustrated as entirely surrounding the first conductor part 131. In an implementation, the first foaming part 132 may be in a position corresponding to the terrace part T. The first foaming part 132 may include foaming particles that foam under predetermined temperature conditions. If the secondary battery 100 is exposed to high temperatures, an electrolyte solution may evaporate and gas may be generated, and thus, the electrode assembly 110 may be improperly deformed and, in severe cases, ignition may occur. Here, the predetermined temperature conditions refer to conditions in which foaming particles may foam first before reaching such situations. In an implementation, foaming particles may be made of a material that may foam if exposed to at least 100° C. for more than 10 seconds, and may include, e.g., azodicarbonamide (ADCA), benzene sulfonyl hydrazide (OBSH), and N, N′-dinitroso pentamethylene tetramine (DPT). In an implementation, the amount of heat required for the foaming particles to foam may be greater than the amount of heat required for the internal insulating layer 121 of the case 120 to be thermally bonded.

The first lower adhesive layer 133 may have a larger width (e.g., extend further in an X direction) than the first conductor part 131 and the first foaming part 132 and may be between the first foaming part 132 and the terrace part T of the lower case 120-1. In addition, the first lower adhesive layer 133 may be bonded and fixed to the terrace part T of the lower case 120-1. In an implementation, in the process of thermally bonding the lower case 120-1 and the upper case 120-2 along the terrace part T, the first lower adhesive layer 133 may be thermally bonded together to the terrace part T of the lower case 120-1. The first lower adhesive layer 133 may be made of a material that has insulating properties and a relatively low thermal conductivity, e.g., a material having a thermal conductivity of approximately 0.1-0.2 W/mK. In an implementation, the first lower adhesive layer 133 may be made of polypropylene (PP). Therefore, if thermally bonded as described above, the heat may be transferred to the first foaming part 132 through the first lower adhesive layer 133, thereby preventing the foaming particles from foaming.

The first upper adhesive layer 134 may be formed in the same configuration as the first lower adhesive layer 133. That is, the first upper adhesive layer 134 may have a larger width than the first conductor part 131 and the first foaming part 132, and may be between the first foaming part 132 and the terrace part T of the upper case 120-2. In addition, the first upper adhesive layer 134 may be bonded and fixed to the terrace part T of the upper case 120-2. In an implementation, in the process of thermally bonding the lower case 120-1 and the upper case 120-2 along the terrace part T, the first upper adhesive layer 134 may be thermally bonded together to the terrace part T of the upper case 120-2. The first upper adhesive layer 134 may be made of a material that has insulating properties and a relatively low thermal conductivity, e.g., a material having a thermal conductivity of approximately 0.1-0.2 W/mK. In an implementation, the first upper adhesive layer 134 may be made of polypropylene (PP). Therefore, as described above, if thermally bonded, the heat may be transferred to the first foaming part 132 through the first upper adhesive layer 134, thereby preventing the foaming particles from foaming.

The second strip terminal 140 may be formed in the same configuration as the first strip terminal 130. Therefore, referring to FIG. 2, the second strip terminal 140 will be described with reference to the reference numerals in parentheses in FIG. 2.

The second strip terminal 140 may be drawn out from the electrode assembly 110. For example, the second strip terminal 140 may extend from the electrode assembly. In an implementation, the second strip terminal 140 may include a second conductor part 141, a second foaming part 142, a second lower adhesive layer 143, and a second upper adhesive layer 144.

The second conductor part 141 may be welded to the second electrode tab 112A of the second electrode plate 112 of the electrode assembly 110 and may extend outward between the lower case 120-1 and the upper case 120-2. The second conductor part 141 may be made of, e.g., aluminum or an aluminum alloy. In an implementation, if the second conductor part 141 is made of aluminum, the second conductor part 141 may have a thermal conductivity of approximately 200-210 W/mK, and, e.g., if the second conductor part 141 has a thickness of 80 μm, a width of 50 mm, and a length of 40 mm, the second conductor part 141 may have resistance of approximately 0.2-0.3 mΩ. In this case, when an overcurrent of 25 A was applied for about 90 seconds, it was observed that the second conductor part 141 generated heat of about 90-100° C.

The second foaming part 142 may at least partially surround the second conductor part 141. In FIG. 2, the second foaming part 142 is illustrated as entirely surrounding the second conductor part 141. In an implementation, the second foaming part 142 may be in a position corresponding to the terrace part T. The second foaming part 142 may include foaming particles that foam under predetermined temperature conditions. If the secondary battery 100 is exposed to high temperatures, an electrolyte solution may evaporate and gas may be generated, and thus, the electrode assembly 110 may be improperly deformed and, in severe cases, ignition may occur. Here, the predetermined temperature conditions refer to conditions in which foaming particles may foam first before reaching such situations. In an implementation, foaming particles may be made of a material that may foam if exposed to at least 100° C. for more than 10 seconds, and may include, e.g., ADCA, OBSH, and DPT. In an implementation, the amount of heat required for the foaming particles to foam may be greater than the amount of heat required for the internal insulating layer 121 of the case 120 to be thermally bonded.

The second lower adhesive layer 143 may have a larger width (e.g., extend further in an X direction) than the second conductor part 141 and the second foaming part 142 and may be between the second foaming part 142 and the terrace part T of the lower case 120-1. In an implementation, the second lower adhesive layer 143 may be bonded and fixed to the terrace part T of the lower case 120-1. In an implementation, in the process of thermally bonding the lower case 120-1 and the upper case 120-2 along the terrace part T, the second lower adhesive layer 143 may be thermally bonded together to the terrace part T of the lower case 120-1. The second lower adhesive layer 143 may be made of a material that has insulating properties and a relatively low thermal conductivity, e.g., a material having a thermal conductivity of approximately 0.1-0.2 W/mK. In an implementation, the second lower adhesive layer 143 may be made of polypropylene. Therefore, as described above, if thermally bonded, the heat may be transferred to the second foaming part 142 through the second lower adhesive layer 143, thereby preventing the foaming particles from foaming.

The second upper adhesive layer 144 may be formed in the same configuration as the second lower adhesive layer 143. That is, the second upper adhesive layer 144 may be formed to have a larger width than the second conductor part 141 and the second foaming part 142 may be between the second foaming part 142 and the terrace part T of the upper case 120-2. In an implementation, the second upper adhesive layer 144 may be bonded and fixed to the terrace part T of the upper case 120-2. In an implementation, in the process of thermally bonding the lower case 120-1 and the upper case 120-2 along the terrace part T, the second upper adhesive layer 144 may be thermally bonded together to the terrace part T of the upper case 120-2. The second upper adhesive layer 144 may be made of a material that has insulating properties and a relatively low thermal conductivity, e.g., a material having a thermal conductivity of approximately 0.1-0.2 W/mK. In an implementation, the second upper adhesive layer 144 may be made of polypropylene. Therefore, as described above, if thermally bonded, the heat may be transferred to the second foaming part 142 through the second upper adhesive layer 144, thereby preventing the foaming particles from foaming.

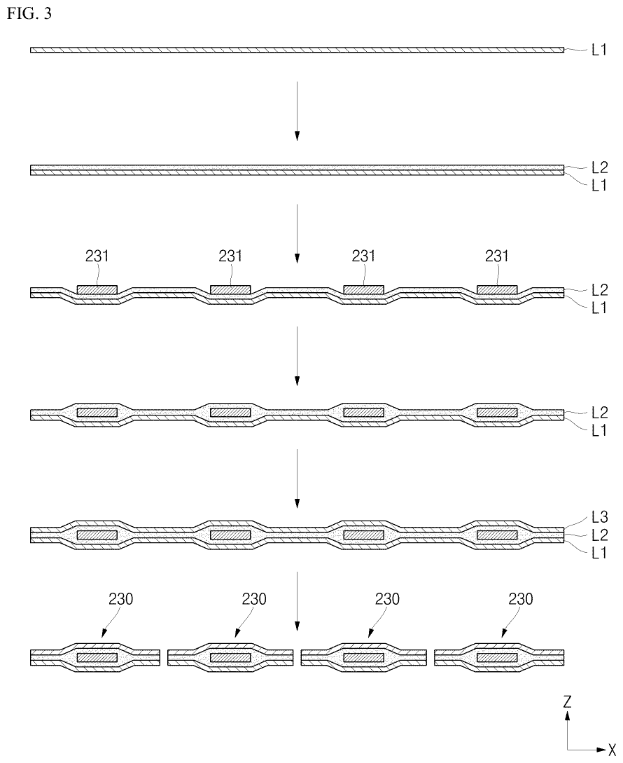

FIG. 3 is a cross-sectional view of a first strip terminal 230 of a secondary battery according to a second embodiment of the present disclosure, showing the corresponding part in FIG. 2.

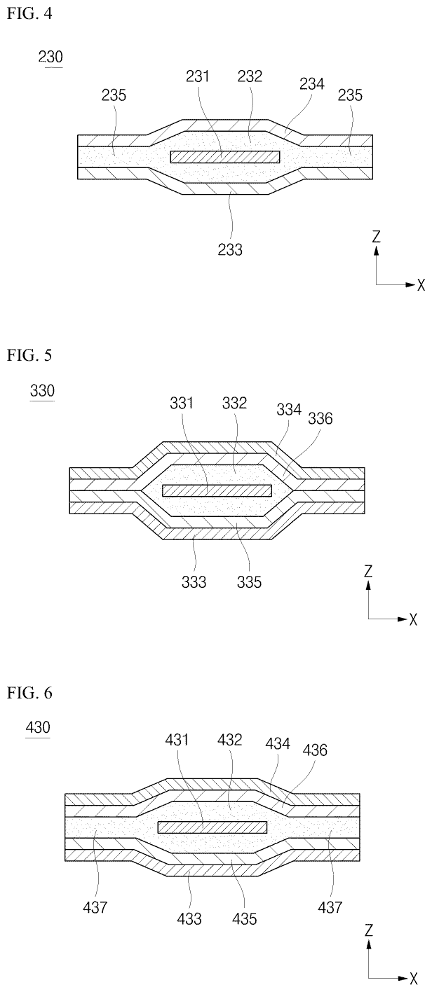

FIG. 4 shows a process of manufacturing the first strip terminal 230 of the secondary battery according to the second embodiment of the present disclosure.

The secondary battery according to the second embodiment of the present disclosure may include an electrode assembly, a case, a first strip terminal 230, and a second strip terminal. However, the electrode assembly and the case of the secondary battery according to the second embodiment of the present disclosure may have the same configuration as the electrode assembly 110 and the case 120 of the secondary battery 100 according to the first embodiment of the present disclosure. Therefore, repeated explanations regarding this will be omitted.

Referring to FIGS. 2 and 3 by comparison, a difference exists in that, while the first foaming part 132 of the first strip terminal 130 of the secondary battery 100 according to the first embodiment of the present disclosure may surround the first conductor part 131 and the first lower adhesive layer 133 and the first upper adhesive layer 134 may be in contact with each other at opposite ends of the first strip terminal in the width direction, the first strip terminal 230 of the secondary battery according to the second embodiment of the present disclosure may further include a first foaming-part extension part 235, and thus, the first lower adhesive layer 233 and the first upper adhesive layer 234 may be spaced apart from each other by the first foaming-part extension part 235 at opposite ends of the first strip terminal in the width direction (e.g. X direction). For example, as illustrated in FIG. 3, the first foaming-part extension part 235 may be between the first lower adhesive layer 233 and the first upper adhesive layer 235.

In an implementation, the first foaming-part extension part 235 may extend from the first foaming part 232 to opposite sides in the width direction. In an implementation, opposite ends of the first foaming-part extension part 235 in the width direction may coincide with opposite ends of the first lower and upper adhesive layers 233 and 234 in the width direction.

The first foaming-part extension part 235 may be made of the same material as the first foaming part 232. Therefore, there may be no clear boundary between the first foaming part 232 and the first foaming-part extension part 235, and the first foaming part 232 and the first foaming-part extension part 235 may be integrally formed with each other.

Referring to FIG. 4, the first strip terminal 230 may be manufactured in the following manner.

First, a member L1 for forming the first lower adhesive layer 233 may be placed and prepared to be elongated in the width direction. Next, a material L2 for forming the first foaming part 232 and the first foaming-part extension part 235 may be entirely placed on the member L1, and the first conductor part 231 may be then placed on the material L2 at regular intervals along the width direction (e.g., X direction).

Then, the material L2 for forming the first foaming part 232 and the first foaming-part extension part 235 may be placed thereon, and a member L3 for forming the first upper adhesive layer 234 may then be placed and prepared to be elongated in the width direction.

Lastly, spaces between the first conductor parts 231 may be cut at regular intervals.

In this way, each cut section may form one first strip terminal 230, and thus a plurality of first strip terminals 230 can be manufactured easily and quickly.

Except that the first strip terminal 230 may further include the first foaming-part extension part 235, and that there may be a structural change accordingly, the first strip terminal 230 may be formed in the same configuration as the first strip terminal 130 of the secondary battery 100 according to the first embodiment of the present disclosure. Therefore, repeated explanations for the rest will be omitted.

Furthermore, the second strip terminal of the secondary battery according to the second embodiment of the present disclosure may be formed to have the same structure as the first strip terminal 230. Therefore, repeated explanations will also be omitted.

FIG. 5 is a cross-sectional view of a first strip terminal 330 of a secondary battery according to a third embodiment of the present disclosure, showing the corresponding part in FIG. 2.

The secondary battery according to the third embodiment of the present disclosure may include an electrode assembly, a case, a first strip terminal 330, and a second strip terminal. However, the electrode assembly and the case of the secondary battery according to the third embodiment of the present disclosure may have the same configuration as the electrode assembly 110 and the case 120 of the secondary battery 100 according to the first embodiment of the present disclosure. Therefore, repeated explanations will also be omitted.

Referring to FIGS. 2 and 5 by comparison, a difference exists in that the first strip terminal 330 of the secondary battery according to the third embodiment of the present disclosure may further include a first lower heat-resistant layer 335 and a first upper heat-resistant layer 336.

The first lower heat-resistant layer 335 may be between the first foaming part 332 and the first lower adhesive layer 333. The first lower heat-resistant layer 335 may be made of a material having a higher melting point than the first lower adhesive layer 333. In an implementation, if the melting point of the first lower adhesive layer 333 is about 120-140° C., the melting point of the first lower heat-resistant layer 335 may be about 160-165° C.

The first upper heat-resistant layer 336 may be between the first foaming part 332 and the first upper adhesive layer 334. This first upper heat-resistant layer 336 may be made of a material having a higher melting point than the first upper adhesive layer 334. In an implementation, if the melting point of the first upper adhesive layer 334 is about 120-140° C., the melting point of the first upper heat-resistant layer 336 may be about 160-165° C.

By the first lower and upper heat-resistant layers 335 and 336, if thermally bonded along the terrace part, the heat may be transferred from the first lower and upper adhesive layers 333 and 334 to the first foaming part 332, thereby more effectively preventing foaming particles from foaming.

Except that the first strip terminal 330 may further include the lower heat-resistant layer 335, and that there may be a structural change accordingly, the first strip terminal 330 may be formed in the same configuration as the first strip terminal 130 of the secondary battery 100 according to the first embodiment of the present disclosure. Therefore, repeated explanations for the rest will be omitted.

Furthermore, the second strip terminal of the secondary battery according to the third embodiment of the present disclosure may be formed to have the same structure as the first strip terminal 330. Therefore, repeated explanations will also be omitted.

FIG. 6 is a cross-sectional view of a first strip terminal 430 of a secondary battery according to a fourth embodiment of the present disclosure, showing the corresponding part in FIG. 2.

The secondary battery according to the fourth embodiment of the present disclosure may include an electrode assembly, a case, a first strip terminal 430, and a second strip terminal. However, the electrode assembly and the case of the secondary battery according to the fourth embodiment of the present disclosure may have the same configuration as the electrode assembly 110 and the case 120 of the secondary battery 100 according to the first embodiment of the present disclosure. Therefore, repeated explanations will also be omitted.

Referring to FIGS. 5 and 6 by comparison, a difference exists in that, while the first foaming part 332 of the first strip terminal 330 of the secondary battery according to the third embodiment of the present disclosure may surround the first conductor part 331 and the first lower heat-resistant layer 335 and the first upper heat-resistant layer 336 may be in contact with each other at opposite ends of the first strip terminal in the width direction, the first strip terminal 430 of the secondary battery according to the fourth embodiment of the present disclosure may further include a first foaming-part extension part 437, and thus, the first lower heat-resistant layer 435 and the first upper heat-resistant layer 436 may be spaced apart from each other by the first foaming-part extension part 437 at opposite ends of the first strip terminal in the width direction (e.g., X direction). For example, as illustrated in FIG. 6, the first foaming-part extension part 437 may be between the first lower heat-resistant layer 435 and the first upper heat-resistant layer 436.

In an implementation, the first foaming-part extension part 437 may extend from the first foaming part 432 to opposite sides in the width direction. In particular, opposite ends of the first foaming-part extension part 437 in the width direction may coincide with opposite ends of the first lower and upper heat-resistant layers 435 and 436 in the width direction and opposite ends of the first lower and upper adhesive layers 433 and 434 in the width direction.

The first foaming-part extension part 437 may be made of the same material as the first foaming part 432. Therefore, there may be no clear boundary between the first foaming part 432 and the first foaming-part extension part 437, and it the first foaming part 432 and the first foaming-part extension part 437 may be integrally formed with each other.

The first strip terminal 430 may be manufactured in the following manner.

First, a member for forming the first lower adhesive layer 433 may be placed and prepared to be elongated in the width direction. Next, a material for forming the first lower heat-resistant layer 335 may be entirely placed on the member for forming the first lower adhesive layer 433.

Then, a material for forming the first foaming part 432 and the first foaming-part extension part 437 may be placed entirely on the material for forming the first lower heat-resistant layer 435, and the first conductor part 431 may be placed on the material for forming the first foaming part 432 and the first foaming-part extension part 437 at regular intervals along the width direction (e.g., X direction).

Then, the material for forming the first foaming part 432 and the first foaming-part extension part 437 may be placed once more and the member for forming the first upper heat-resistant layer 436 may then be placed on the material for forming the first foaming part 432 and the first foaming-part extension part 437. Thereafter, the member for forming the first upper adhesive layer 434 may be prepared to be elongated in the width direction and placed on the member for forming the first upper heat-resistant layer 436.

Lastly, spaces between the first conductor parts 431 may be cut at regular intervals.

In this way, each cut section may form one first strip terminal 430, and thus a plurality of first strip terminals 430 may be manufactured easily and quickly.

Except that the first strip terminal 430 may further include the first foaming-part extension part 437, and that there may be a structural change accordingly, the first strip terminal 430 may be formed in the same configuration as the first strip terminal 130 of the secondary battery according to the third embodiment of the present disclosure. Therefore, repeated explanations for the rest will be omitted.

Furthermore, the second strip terminal of the secondary battery according to the fourth embodiment of the present disclosure may be formed to have the same structure as the first strip terminal 430. Therefore, repeated explanations will also be omitted.

By way of summation and review, if secondary batteries are exposed to high temperatures, gas may be generated as an electrolyte solution evaporates, so that an electrode assembly may be improperly deformed, and in severe cases, ignition may occur. Accordingly, technology that may release the gas at an appropriate time is required.

As described above, in embodiments of the present disclosure, the strip terminal may include a foaming part containing foaming particles that foam under predetermined temperature conditions, and thus, the foaming particles may foam when the secondary battery is exposed to high temperatures, creating a gap between the case and the strip terminal. Therefore, by discharging gas through the gap, the electrode assembly, and even the secondary battery, may be prevented from being improperly deformed or ignited. In particular, in the strip terminal, the foaming part may surround the conductor part with relatively excellent heat conductivity, so that heat may be transferred to the foaming part more effectively, thereby ensuring that the foaming particles more reliably foam.

Embodiments of the present disclosure provide a secondary battery capable of effectively discharging gas.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery comprising:
an electrode assembly;
a case containing the electrode assembly; and
a strip terminal including:
a conductor part connected to the electrode assembly and extending outward,
a foaming part surrounding the conductor part and containing foaming particles that foam under predetermined temperature conditions, and
an adhesive layer surrounding the foaming part and bonded to the case.

2. The secondary battery as claimed in claim 1, wherein the foaming part at least partially surrounds the conductor part.

3. The secondary battery as claimed in claim 1, wherein the foaming part entirely surrounds the conductor part.

4. The secondary battery as claimed in claim 1, wherein:
the case includes:
a lower case having a concave portion accommodating the electrode assembly, and
an upper case covering the lower case,
the case is thermally bonded along a terrace part of the lower case and a terrace part of the upper case,
the conductor part extends outwardly through the lower case and the upper case, and
the adhesive layer includes:
a lower adhesive layer between the foaming part and the terrace part of the lower case, and
an upper adhesive layer between the foaming part and the terrace part of the upper case.

5. The secondary battery as claimed in claim 4, wherein an amount of heat required for the foaming particle to foam is greater than an amount of heat required to thermally bond the lower case and the upper case.

6. The secondary battery as claimed in claim 4, wherein the lower and upper adhesive layers each have a larger width than the foaming part.

7. The secondary battery as claimed in claim 6, wherein the lower adhesive layer and the upper adhesive layer are in contact with each other at opposite ends of the strip terminal in a width direction.

8. The secondary battery as claimed in claim 6, wherein:
the strip terminal further includes a foaming-part extension part extending from the foaming part to opposite ends of the strip terminal in a width direction, and
the lower adhesive layer and the upper adhesive layer are spaced apart from each other by the foaming-part extension part at the opposite ends of the strip terminal in the width direction.

9. The secondary battery as claimed in claim 8, wherein opposite ends of the foaming-part extension part in the width direction coincide with opposite ends of the lower and upper adhesive layers in the width direction.

10. The secondary battery as claimed in claim 1, wherein the strip terminal further includes a heat-resistant layer between the foaming part and the adhesive layer.

11. The secondary battery as claimed in claim 10, wherein the heat-resistant layer is made of a material having a higher melting point than the adhesive layer.

12. The secondary battery as claimed in claim 10, wherein:
the case includes:
a lower case having a concave portion accommodating the electrode assembly, and
an upper case covering the lower case,
the case is thermally bonded along a terrace part of the lower case and a terrace part of the upper case,
the conductor part extends outwardly between the lower case and the upper case,
the adhesive layer includes:
a lower adhesive layer between the foaming part and the terrace part of the lower case, and
an upper adhesive layer between the foaming part and the terrace part of the upper case, and
the heat-resistant layer includes:
a lower heat-resistant layer between the foaming part and the lower adhesive layer, and
an upper heat-resistant layer between the foaming part and the upper adhesive layer.

13. The secondary battery as claimed in claim 12, wherein an amount of heat required for the foaming particles to foam is greater than an amount of heat required to thermally bond the lower case and the upper case.

14. The secondary battery as claimed in claim 13, wherein the lower and upper adhesive layers and the lower and upper heat-resistant layers each have larger widths than the foaming part.

15. The secondary battery as claimed in claim 14, wherein the lower adhesive layer and the upper adhesive layer are in contact with each other at opposite ends of the strip terminal in a width direction.

16. The secondary battery as claimed in claim 14, wherein:
the strip terminal further includes a foaming-part extension part extending from the foaming part to opposite ends of the strip terminal in a width direction, and
the lower heat-resistant layer and the upper heat-resistant layer are spaced apart from each other by the foaming-part extension part at the opposite ends of the strip terminal in the width direction.

17. The secondary battery as claimed in claim 16, wherein opposite ends of the foaming-part extension part in the width direction coincide with opposite ends of the lower and upper adhesive layers in the width direction and opposite ends of the lower and upper heat-resistant layers in the width direction.

18. The secondary battery as claimed in claim 1, wherein the foaming particles include azodicarbonamide (ADCA), benzene sulfonyl hydrazide (OBSH), or N, N′-dinitroso pentamethylene tetramine (DPT).

19. A method of manufacturing a strip terminal, the method comprising:
placing and preparing for elongation in a width direction a member for forming a lower adhesive layer;
placing a material for forming a foaming part and a foaming-part extension part on the member for forming a lower adhesive layer;
placing conductor parts spaced at regular intervals in the width direction on the material for forming a foaming part and a foaming-part extension part;
placing additional material for forming a foaming part and a foaming-part extension part on the material for forming a second foaming part and a foaming-part extension part and the conductor parts;
placing and preparing for elongation in the width direction a member for forming an upper adhesive layer on the additional material for forming a foaming part and a foaming-part extension part; and
cutting placed materials and members at regular intervals along the width direction in spaces between the conductor parts spaced at regular intervals along the width direction.

20. A method of manufacturing a strip terminal, the method comprising:
placing and preparing for elongation in a width direction a member for forming a lower adhesive layer;
placing a material for forming a lower heat-resistant layer on the member for forming a lower adhesive layer;
placing a material for forming a foaming part and a foaming-part extension part on the material for forming a lower heat-resistant layer;
placing conductor parts spaced at regular intervals in the width direction on the material for forming a foaming part and a foaming-part extension part;
placing additional material for forming a foaming part and a foaming-part extension part on the material for forming a second foaming part and a foaming-part extension part and the conductor parts;
placing a material for forming an upper heat-resistant layer on the additional material for forming a foaming part and a foaming-part extension part;
placing and preparing for elongation in the width direction a member for forming an upper adhesive layer on the material for forming an upper heat-resistant layer; and
cutting placed materials and members at regular intervals along the width direction in spaces between the conductor parts spaced at regular intervals along the width direction.
